(19) United States
(12) Patent Application Publication
(10) Pub. No.: US 2013/0248475 A1
(43) Pub. Date: Sep. 26, 2013

(54) Shelf divider and kit

(71) Applicant: Brent Carl Erickson, Thamesville (CA)

(72) Inventor: Brent Carl Erickson, Thamesville (CA)

(21) Appl. No.: 13/506,032

(22) Filed: Mar. 22, 2012

(51) Int. Cl. A47B 96/20; F16B 19/04

(52) U.S. Cl. 211/119.003; 211/184; 411/500

(57) ABSTRACT

A kit for building a shelf divider and shelf divider is described. The kit may include a frontward panel, a rearward panel, and a plurality of slot dividers. The frontward panel may include a first plurality of receptacles. The rearward panel may include a second plurality of receptacles. Each of the plurality of slot dividers may include a first locking mechanism and a second locking mechanism. The first locking mechanism may be disposed at a first end of each slot divider for coupling to one of the first plurality of receptacles of the frontward panel. The second locking mechanism may be disposed at a second end of each slot divider for coupling to one of the second plurality of receptacles of the rearward panel. A rivet for coupling the shelf divider to a shelf is also described.

### FIELD OF THE INVENTION

This invention relates to a shelf divider and, in particular, a kit for building a shelf divider.

### BACKGROUND OF THE INVENTION

Shelf dividers are known in the art to organize and arrange a multitude of objects. They can be used within a home or within a store to neatly arrange items for display. Display shelving is often used within a store to display items for sale. However, there is wide range of shelving types and not all shelving dividers are capable of adapting to the different forms and types of shelving on the market.

### SUMMARY OF THE INVENTION

The present invention is directed to shelf dividers and to kits for building shelf dividers.

It is an object of this invention to provide an improved shelf divider and kit which is configured for easy assembly and adaptable for a wide range of shelving.

In one aspect, the present invention resides in a kit for building a shelf divider. The kit may include a frontward panel, a rearward panel, and a plurality of slot dividers. The frontward panel may include a first plurality of receptacles. The rearward panel may include a second plurality of receptacles. Each of the plurality of slot dividers may include a first locking mechanism and a second locking mechanism. The first locking mechanism may be disposed at a first end of each slot divider for coupling to one of the first plurality of receptacles of the frontward panel. The second locking mechanism may be disposed at a second end of each slot divider for coupling to one of the second plurality of receptacles of the rearward panel.

In another aspect, the present invention resides in a shelf divider. The shelf divider may include a frontward panel, a rearward panel, and a plurality of slot dividers. The frontward panel may include a first plurality of receptacles. The rearward panel may include a second plurality of receptacles. Each of the plurality of slot dividers may include a first locking mechanism and a second locking mechanism. The first locking mechanism may be disposed at a first end of each slot divider for coupling to one of the first plurality of receptacles of the frontward panel. The second locking mechanism may be disposed at a second end of each slot divider for coupling to one of the second plurality of receptacles of the rearward panel.

In another aspect, the present invention resides in a rivet. The rivet may include a top portion and an insertion portion. The insertion portion may extend in a longitudinal direction and may include a first member and a second member separated by an insertion distance. The insertion portion may also include a shelf portion, an engagement portion and a release portion. The shelf portion may be coupled to the top portion, the shelf portion having a shelf portion length. The release portion may be configured to allow the rivet to be removed from a hole.

Further and other features of the invention will be apparent to those skilled in the art from the following detailed description of the embodiments thereof.

### BRIEF DESCRIPTION OF THE DRAWINGS

Reference may now be had to the following detailed description taken together with the accompanying drawings in which:

FIG. 1 shows a perspective view of a shelf divider in accordance with an embodiment of the present invention;

FIG. 2 shows a front elevation view of the shelf divider of FIG. 1 in accordance with an embodiment of the present invention;

FIG. 3 shows a rear elevation view of the shelf divider of FIG. 1 in accordance with an embodiment of the present invention;

FIG. 4A shows a first side view of a slot divider in accordance with an embodiment of the present invention;

FIG. 4B shows a second side view of the slot divider of FIG. 4 in accordance with an embodiment of the present invention;

FIG. 5 shows a partial perspective view of a bottom corner of a slot divider in accordance with an embodiment of the present invention;

FIG. 6A shows a partial perspective view of receptacle as part of a frontward or rearward panel in accordance with an embodiment of the present invention;

FIG. 6B shows a partial perspective view of a bottom corner of a slot divider in accordance with an embodiment of the present invention;

FIG. 7 shows a perspective view of a slot median in accordance with an embodiment of the present invention;

FIG. 8 shows a partial perspective view of median apertures of a slot divider in accordance with an embodiment of the present invention;

FIG. 9 shows a bottom view of a shelf divider in accordance with an embodiment of the present invention;

FIG. 10 shows a top view of a shelf divider in accordance with an embodiment of the present invention;

FIG. 11 shows a perspective view of a shelf divider in accordance with another embodiment of the present invention;

FIG. 12A and FIG. 12B show side views of a slot divider in accordance with another embodiment of the present invention;

FIG. 13 shows a perspective view of a shelf divider in accordance with another embodiment of the present invention;

FIG. 14 shows a perspective view of a shelf divider in accordance with another embodiment of the present invention;

FIG. 15A shows a perspective view of a rivet in accordance with an embodiment of the present invention;

FIG. 15B shows a front view of the rivet of FIG. 15A;

FIG. 15C shows a side view of the rivet of FIG. 15A;

FIG. 15D shows a top view of the rivet of FIG. 15A; and

FIG. 15E shows a bottom view of the rivet of FIG. 15A.

### DETAILED DESCRIPTION OF THE PREFERRED EMBODIMENTS

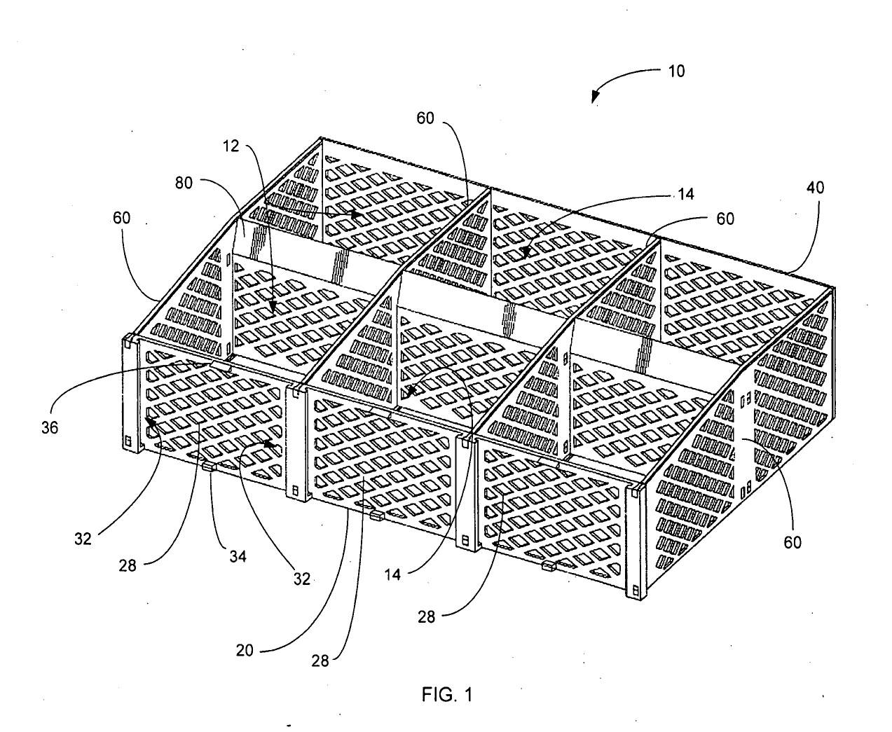

FIG. 1 shows a shelf divider 10 in accordance with a preferred embodiment. The shelf divider 10 may include a frontward panel 20, a rearward panel 40 and two or more slot dividers 60. As seen in FIG. 1, the slot dividers 60 may form the left and right sides of the shelf divider 10, as well as interior walls to form slots 12 between the slot dividers 60 which are positioned side-by-side. The shelf divider 10 may also include slot medians 80 which are coupled to the slot dividers 60. The slot medians 80 may subdivide the slots 12 into front and back bins 14.

While the following description describes the shelf divider 10 once assembled, it should be understood that the frontward panel 20, the rearward panel 40, the plurality of slot dividers 60 and the slot medians 80 are separate pieces, each of which may be formed integrally out of plastic and the like. Furthermore, it should be understood that the different components may form part of a kit that is operable to be assembled for different size shelving and the like. Such a kit may be configured to provide different shelf arrangements, with various slot 12 and bin 14 sizes. In addition, various kits may be combined to form larger and more elaborate shelf dividers 10. The shelf divider arrangements set forth in the preferred embodiments described herein should not be construed as limiting.

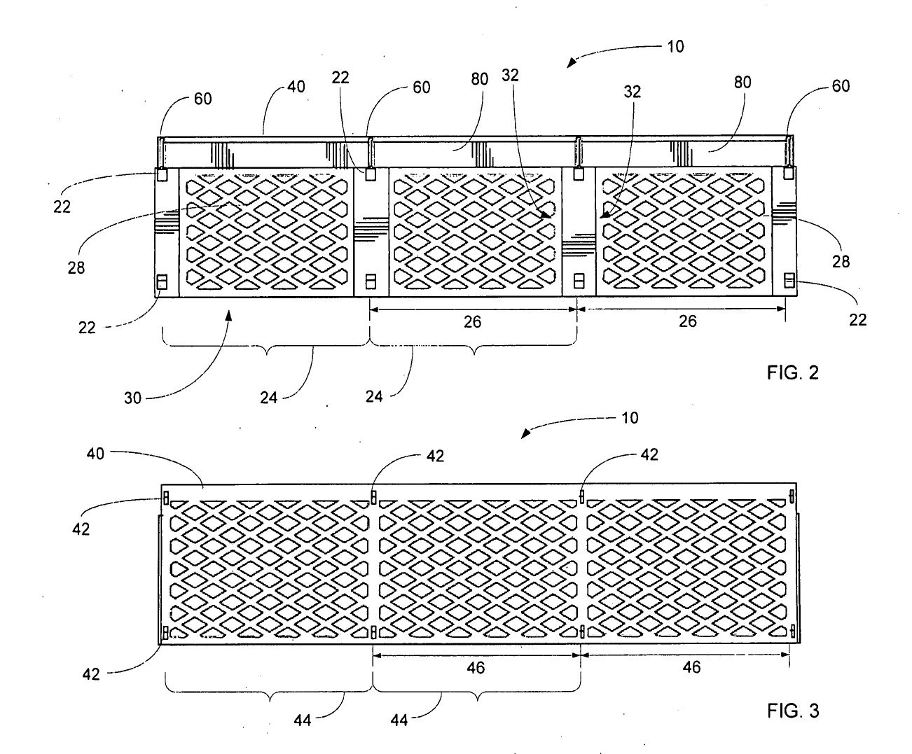

Referring now to FIG. 2, a front elevation view of the shelf divider 10 is shown. As shown, the frontward panel 20 is depicted in front of the rearward panel 40. The rearward panel 40 may be taller than the frontward panel 20. Furthermore, slot medians 80 may be of similar height as the rearward panel 40 such that at least parts of the slot medians 80 are visible over the frontward panel 20 once the shelf divider 10 is assembled.

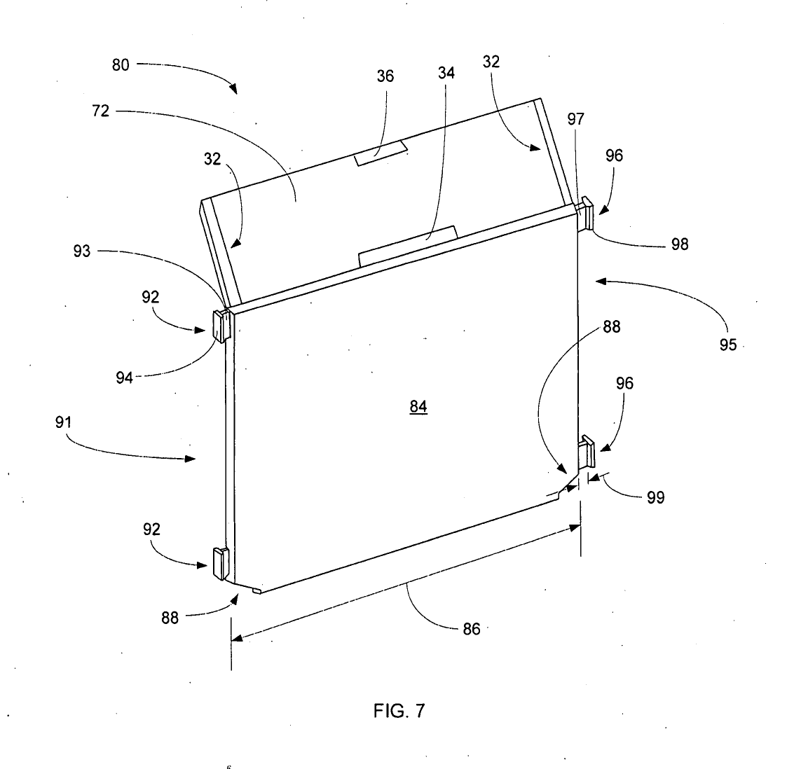

As seen in FIG. 2, the frontward panel 20 includes a plurality of receptacles 22. The receptacles 22 are configured to couple with one of the four slot dividers 60, which are shown edge-on. One or more receptacles 22 may be used to couple each slot divider 60 to the frontward panel 20. As seen in FIG. 2, two receptacles 22 are shown coupling each slot divider 60 in a preferred embodiment. One receptacle 22 is shown coupling each slot divider 60 at the top of the frontward panel 20. One receptacle 22 is shown coupling each slot divider 60 at or near the bottom of the frontward panel 20. Each receptacle 22 of the frontward panel 20 may be configured with a latch strike 23 (best seen in FIG. 6A) for coupling with the slot dividers 60.

The frontward panel 20 may be divided into equal segments 24 having a segment length 26. The frontward panel 20 may be segmented by the receptacles 22. As seen in FIG. 2, the segment length 26 of each equal segment 24 may be bounded by the receptacles 22. In a preferred embodiment, each equal segment 24 is bounded by two receptacles 22 on either side of each equal segment 24.

Each equal segment 24 of the frontward panel 20 may include a slot label holder 30. The slot label holder 30 may be configured to secure a slot label (not shown). The slot label may be secured adjacent to an outward face 28 of each equal segment 24 of the frontward panel 20. In this manner the slot label holder 30 is operable to provide an indicia of what is contained within the slot 12 and/or bin 14 when placed on a shelf.

As best seen in FIG. 1, the slot label holder 30 may include a pair of opposing grooves 32 and an insertion member 34. The pair of opposing grooves 32 may be used to receive opposing sides of the slot label. For example, the slot label may slide into the opposing grooves 32.

The insertion member 34 may be configured as part of the slot label holder 30 to stop further insertion of the slot label. For example, the insertion member 34 may be integrally formed as part of the pair of opposing grooves 32 such that once the slot label is fully received or inserted into the slot label holder 30, the insertion member 34 (as part of the opposing grooves 32) stops the slot label from being further inserted.

In another embodiment, the insertion member 34 may include an abutment or other physical device for stopping the further insertion of the slot label. For example, the insertion member 34 may be attached or coupled to the opposing grooves 32. In another embodiment, the insertion member 34 may include an abutment coupled to the outward face of each equal segment 24. In a preferred embodiment, the abutment may be disposed, preferably centrally, between the opposing grooves 32 of each slot label holder 30. Furthermore, the abutment may include a block or other shape and the like.

The slot label holder 30 may also include a withdrawal member 36. The withdrawal member may be configured to stop the withdrawal of the slot label once the slot label is fully received or inserted in the slot label holder 30. For example, the withdrawal member 36 may include an abutment or other shape and the like. Furthermore, the withdrawal member 36 may be centrally disposed between the opposing sides of each slot label holder 30. In a preferred embodiment, the withdrawal member 36 may include a wedge or other device such that the withdrawal member 36 allows for the insertion of the slot label into the slot label holder 30, but resists the withdrawal of said slot label once fully inserted or received. In another preferred embodiment, the withdrawal member 36 may include a spring or other mechanical or electromechanical device (not shown) such that the withdrawal member 36 allows the slot label to be fully inserted easily but resists the withdrawal of the slot label once the slot label is fully inserted or received.

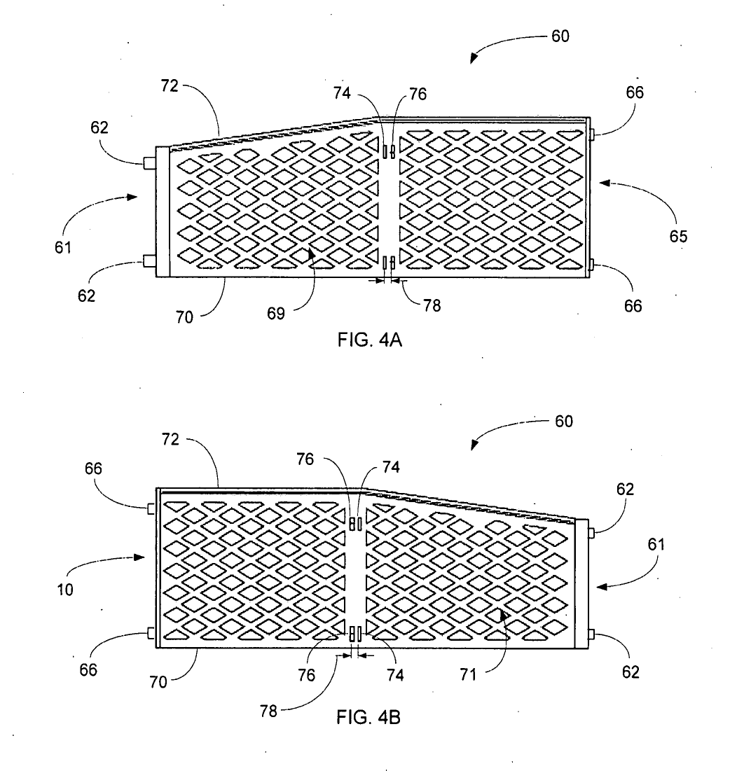

Referring now to FIG. 3, a rear elevation view of the shelf divider 10 is shown. The rearward panel 40 includes a plurality of receptacles 42. The receptacles 42 are configured to couple with one of the slot dividers 60. One or more receptacles 42 may be used to couple each slot divider 60 to the rearward panel 40. As seen in FIG. 3, two receptacles 42 are shown coupling each slot divider 60 in a preferred embodiment. Each receptacle 42 of the rearward panel 40 may be configured with a latch strike 43 (best seen in FIG. 6A) for coupling with the slot dividers 60.

The rearward panel 40 may be divided into equal segments 44 having a segment length 46. The rearward panel 40 may be segmented by the receptacles 42. As seen in FIG. 3, the segment length 46 of each segment 44 may be bounded by the receptacles 42. In a preferred embodiment, each equal segment 44 is bounded by two receptacles 42 on either side of each equal segment 24. Furthermore, the equal segments 44 of the rearward panel 40 may be equal to the equal segments 24 of the frontward panel 24.

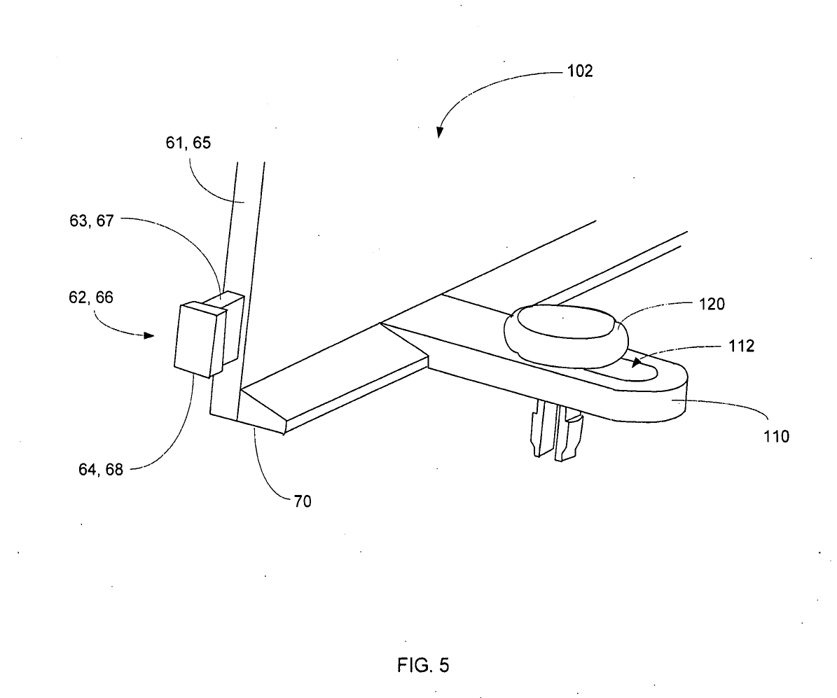

FIG. 4A and FIG. 4B show a slot divider 60 in a preferred embodiment. The slot divider 60 may have a base 70 for connecting to a shelf (not shown) and a top rail 72. As shown in FIG. 4A and FIG. 4B, a first side 69 of the slot divider 60 seen in FIG. 4A and a second side 71 seen in FIG. 4B may have a similar construction.

The slot divider 60 is configured with a first end 61 having one or more first locking mechanisms 62. The first locking mechanism 62 may be disposed at the first end 61 of the slot divider 60. The first locking mechanism 62 may be configured to couple to one of the receptacles 22 of the frontward panel 20. The slot divider 60 is also configured with a second end 65 having one or more second locking mechanisms 66. The second locking mechanism 66 may be disposed at the second end 65 of the slot divider 60. The second locking mechanism 66 may be configured to couple to one of the receptacles 42 of the rearward panel 40.

As illustrated, the height of the slot divider 60 may be different near the first end 61 than near the second end 65. The height of the slot divider 60 near the first end 61 may be similar to the height of the frontward panel 20. The height of the slot divider 60 near the second end 65 may be similar to the height of the rearward panel 40. The height of the slot divider 60 may transition from the one height to another height, uniformly or abruptly. Furthermore, the top rail 72 may be configured to provide additional strength and rigidity to allow for this transition.

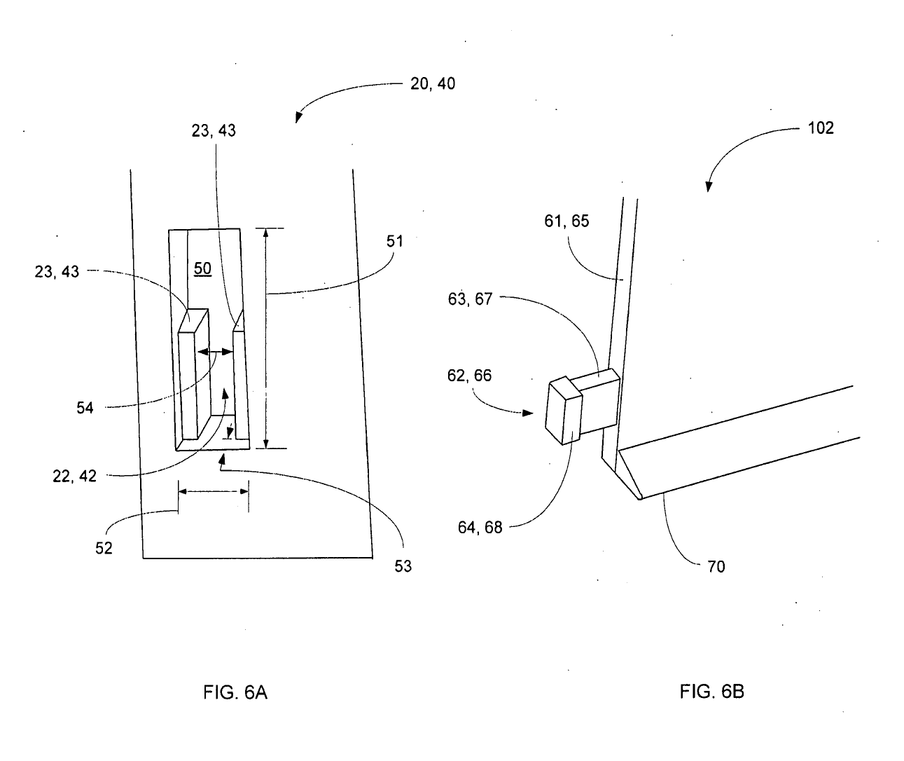

Looking briefly at FIG. 5, a generic bottom corner 102 of a slot divider 60 is shown in accordance with an embodiment of the present invention. The generic corner 102 can be on either the first side 61 or the second side 65 of the slot divider 60 and shows either the first locking mechanism 62 or the second locking mechanism 66.

As illustrated, the first locking mechanism 62 may include a first member 63 extending from the first end 61 of the slot divider 60. The first member 63 of the first locking mechanism 62 may terminate at a first latch 64. The first member 63 and the first latch 64 of the first locking mechanism 62 may form a male component for coupling to a corresponding female component (i.e. receptacles 22) of the frontward panel 20. While the first latch 64 in FIG. 5 is shown as a block, it should be understood that other shapes of the first latch 64 may be used.

The second locking mechanism 66 may include a second member 67 extending from the second end 65 of the slot divider 60. The second member 67 of the second locking mechanism 66 may terminate at a second latch 68. As shown in the generic bottom corner 102 of FIG. 5, the second locking mechanism 66 may have a similar construction as the first locking mechanism 62, with the second locking mechanism 66 forming a male component for coupling to the rearward panel 40. In at least one embodiment, the construction of the first locking mechanism 62 is identical to the construction of the second locking mechanism 66. In other embodiments, the dimensions of the first and second members 63, 67 and first and second latches 64, 65 may be different. For example, the first and second locking mechanisms 62, 66 may have different heights, widths, shapes and the like.

In at least one embodiment, the first locking mechanism 62 of the frontward panel 20 may be larger than the second locking mechanism 66 of the rearward panel 40. As the frontward panel 20 is more likely to be handled and accessed by users and/or customers, a larger first locking mechanism 62 may provide additional strength and rigidity to the coupling between the slot divider 60 and the frontward panel 20 to withstand aggressive usage. For example, the coupling at the front of the shelf divider 10 is likely to be tested every time the slot label is changed in the slot label holder 10. Therefore, a strong coupling at the front of the shelf divider 10 may be advantageous to prevent separation of the slot dividers 60 from the frontward panel 20 once the shelf divider 10 has been installed. The coupling at the rear of the shelf divider 10 may not be handled as frequently, as the rearward panel 40 is less likely to be accessed. Therefore, such a strong coupling at the rear of the shelf divider 10, which may entail additional material and resources, may not be required.

FIG. 5 also shows the slot divider 60 having at least one coupling device 110. The coupling device 110 may attached to the base 70. In some embodiments, the base 70 and the one or more coupling devices 110 are integrally formed as single piece, as part of the slot divider 60. For example, the slot divider 60 may be injection moulded out of a single piece of plastic. Other methods of manufacturing may also be used.

The base 70 may extend from one or both sides of the slot divider 60. For example, the base 70 may extend from either the first side 69 and/or the second side 71 of the slot divider 60. Similarly, the coupling device 110 may extend from one or both sides of the slot divider 60. In at least one embodiment, the base 70 and the coupling device 110 may extend from the same side (i.e. the first side 69 or the second side 71) of the slot divider 60. In other embodiments, the base 70 and the coupling device 110 may extend from opposite sides 69, 71 of the slot divider.

The coupling device 110 may have a coupling device aperture 112. The coupling device aperture 112 may be used by a rivet 120 or other fastener or attachment mechanism to couple or fasten the base 70 of the slot divider 60 to a shelf (not shown). It is often the case that shelving (i.e. conventional or typical shelving) will have standard holes or apertures in the shelving for attaching conventional dividers and/or other components. The coupling device 110 may use such holes in the shelving to couple the base 70 of the slot divider 60 to the shelving using the rivet 120 inside the coupling device aperture 112.

Reference is now made to FIG. 6A and FIG. 6B to illustrate coupling the slot dividers 60 to the frontward panel 20 and rearward panel 40 in a preferred embodiment. As previously described, the frontward panel 20 is coupled to a slot divider 60 using the first locking mechanism 62 of the slot divider 60 and a receptacle 22 of the frontward panel 20. Similarly, the rearward panel 40 is coupled to a slot divider 60 using the second locking mechanism 66 of the slot divider 60 and a receptacle 42 of the frontward panel 40.

In a preferred embodiment, a corresponding or matching latch and strike (i.e. strike plate) may be used. For example, the first and second locking mechanism 62, 66 may be formed for insertion into a corresponding latch strike 23, 43 of the frontward panel 20 and rearward panel 40, respectively. Other coupling mechanisms are possible. For example, the first and second locking mechanisms 62, 66 may be any other type of fastener or hardware device capable of coupling the first locking mechanism 62 to the receptacles 22 of the frontward panel 20 and capable of coupling the second locking mechanism 66 to the receptacles 42 of the rearward panel 40. For example, the first and second locking mechanisms 62, 66 may be a buckle, clamp, clasp, clip, clutch, flange, grommet, pin, retaining ring, tie, nut and bolt and the like. The strike and latch assembly described herein should not be construed as limiting.

FIG. 6A shows a receptacle such as one of the receptacles 22, 42 on either the frontward panel 20 or the rearward panel 40. The receptacle 22, 42 may include a receptacle aperture 50 having an aperture height 51 for receiving the locking mechanism 62, 66 of the slot divider 60. The receptacle 22, 42 may also include a latch strike 23, 43. For example, the latch strike 23, 43 may be formed of two abutments coupled or attached to the sides of the aperture 50. Other arrangements are possible. In a preferred embodiment, the latch strike 23, 43 may be integrally formed with the receptacle 22, 42.

The latch strike 23, 43 may be positioned in only a portion of the aperture 50. For example, as seen in FIG. 6A, the latch strike 23, 43 may be formed in approximately half or less than half of the receptacle 22, 42 and the height of the latch strike 23, 43 may be half or less than half of the aperture height 51 of the receptacle aperture 50.

The receptacle 22, 42 may also have a latch strike width 52 and a latch strike depth 53. The latch strike width 52 may be the distance between opposing walls or sides of the aperture 50. The latch strike depth 53 may be the distance between a side (i.e. outward face 28) of the panel (i.e. frontward panel 20 or rearward panel 40) and the latch strike 23, 43.

The receptacle 22, 42 may also have a member width 54. The member width 54 may correspond to the width of the first or second member 63, 67 of the first and second locking. mechanisms 62, 66 of the slot divider 60. For example, the member width 54 seen in FIG. 6A is the distance between the opposing abutments of the latch strike 23, 43 inside the receptacle 22, 42.

In operation, the first or second locking mechanism 62, 66 may be fully inserted into the receptacle aperture 50. In particular, the first or second locking mechanism 62, 66 may be inserted through the upper portion of the receptacle aperture 50 such that the latch 64, 68 of the locking mechanism 62, 66 is able to proceed past the latch strike 23, 43. Once fully inserted, the first or second locking mechanism 62, 66 may be slid down into a locked position such that the member 63, 67 of the first or second locking mechanism 62, 66 sits between the latch strikes 23, 43 of the receptacle 22, 42 having a member width 54.

Once in the locked position, the first or second latch 64, 68 occupies the space between the latch strike 23, 43 and the side of the slot divider 60 (i.e. in the space defined by the latch strike width 52 and the latch strike depth 53). The first or second latch 64, 68 may be held in the locked position by friction between the slot divider 60 and the frontward panel 20 or the rearward panel 40. Alternatively, or in addition, the first and/or second latch 64, 68 may be held in the locked position by another means, such as by an adhesive, a fastener and the like.

To remove or decouple the slot divider 60 from either the frontward panel 20 or the rearward panel 40, the first or second latch 64, 68 is first lifted up and/or away from the latch strike 23, 43. The first or second locking mechanism 62, 66 may then removed from the receptacle aperture 50 of the receptacles 22, 42 of either the frontward panel 20 or the rearward panel 40.

While a latch and strike plate configuration has been illustrated in a preferred embodiment, it should be understood that other coupling arrangements are possible. For example, the first and second locking mechanisms 62, 66 are shown in a T-shaped configuration. However, other configurations of the first and second locking mechanisms 62, 66 can be used, such as an L-shaped or Y-shaped configuration. Furthermore, the first and second locking mechanisms 62, 66 may have different, rather than identical, configurations. The resulting receptacles 22, 42 of the frontward panel 20 and rearward panel 40 would be changed accordingly.

Returning briefly to FIG. 4A and FIG. 4B, the slot divider 60 may also have a first median aperture 73 and a second median aperture 75 for coupling to a slot median 80. The slot divider 60 may also be configured with additional median apertures. The first median aperture 73 may be separated from the second median aperture 75 by a median separation distance 78.

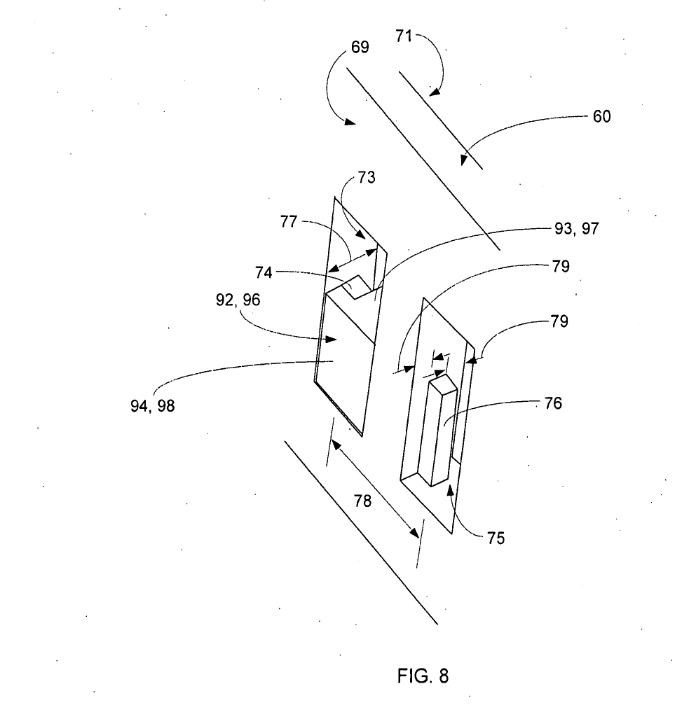

Referring now to FIG. 7, a slot median 80 is shown. The slot median includes a label portion 80 (i.e. a bin label holder) and a divider portion 82. The label portion 82 is configured to secure a bin label (not shown) to the slot median 80. The divider portion 84 is configured to subdivide a slot 12 into two bins 14 (as shown in FIG. 1). The divider portion 84 may have a median length 86 that is equal to the segment length 26 of the frontward panel 20 and the segment length 46 of the rearward panel 40. In this manner, the slot median 80 may subdivide a slot 12 into two separate bins 14.

The label portion 82 of the slot median 80 may have a similar construction to the slot label holder 30 seen in FIG. 1 and described above. The label portion 82 may include a pair of opposing grooves 32 and an insertion member 34. The pair of grooves 32 may be used to receive opposing sides of a label (not shown) for the label portion 82 of the slot median 80. For example, the label may slide into the opposing grooves 32 of the label portion 82. The insertion member 34 may be positioned as part of the label portion 82 to stop further insertion of the label. For example, once the label is fully received or inserted into the label portion 82, the insertion member 34 may stop the label from being further inserted.

The insertion member 34 may include an abutment or other physical device for stopping the further insertion of the label into the label portion 82. For example, the insertion member 34 may be attached or coupled to the opposing grooves 32. In another embodiment, the insertion member 34 may include an abutment coupled to label portion 82. Furthermore, the abutment may include a block or other shape and the like centrally disposed between the opposing grooves 32 of the label portion 82 of each slot median 80.

The label portion 82 of each slot median 80 may also include a withdrawal member 36. The withdrawal member may be configured to stop the withdrawal of the label once the label is fully received or inserted in the label portion 82. For example, the withdrawal member 36 may include an abutment or other shape and the like. The withdrawal member 36 may be centrally disposed between the opposing sides of the label portion 82 for each slot median 80. In a preferred embodiment, the withdrawal member 36 may include a wedge or other device such that the withdrawal member 36 allows for the insertion of the label into the label portion 82 of each slot median 80, but resists the withdrawal of said label once fully inserted or received. In another preferred embodiment, the withdrawal member 36 may include a spring or other mechanical device (not shown) such that the withdrawal member 36 allows the label to be fully inserted but resists the withdrawal of the label once the label is fully inserted or received in the label portion 82 of each slot median 80.

The slot median 80 is configured with a first end 91 having one or more first coupling mechanisms 92 to couple to a slot divider 60. The first coupling mechanisms 92 may be disposed at the first end 91 of the slot median 80. The first coupling mechanism 92 may be configured to couple to either the first median aperture 73 or the second median aperture 75 of the slot divider 60. The first coupling mechanism 92 may include a first member 93 extending from the first end 91 of the slot median 80. The first member 93 of the first coupling mechanism 92 may terminate at a first median latch 94.

The slot median 80 is also configured with a second end 95 having one or more second coupling mechanisms 96. The second coupling mechanisms 96 may be disposed at the second end 95 of the slot median 80. The second coupling mechanism 96 may be configured to couple to either the first median aperture 73 or the second median aperture 75 of the slot divider 60. The second coupling mechanism 96 may include a second member 97 extending from the second end 95 of the slot median 80. The second member 97 of the second coupling mechanism 96 may terminate at a second median latch 98.

The slot median 80 may also include cutouts 88. The cutouts 88 may conform to the shape of the base 70 of the slot dividers 60. In this manner, the bottom of the slot median 80 may sit flush against the shelf (not shown) when assembled as part of the shelf divider 10. Furthermore, both the first end 91 and second end 95 of the slot median 80 may include cutouts 88 for embodiments where the base 70 of the slot divider 60 extends from either or both of the first side 69 or the second side 71 of the slot divider.

The cutout 88 of the slot median 80 may be a chamfer. In other embodiments, the cutout 88 may be an irregular shape to conform to the shape of the base 70 of the slot divider. Fillets and other shapes known in the art may also be used to join the ends 91, 95 of the slot median 80 to its base.

The first coupling mechanism 92 and the second coupling mechanism 96 may have an identical construction. Furthermore, the construction of the first coupling mechanism 92 and the second coupling mechanism 96 may be similar to that of the first locking mechanism 62 and second locking mechanism 66 of the slot divider 60, as best shown in FIG. 5 and illustrated in operation in FIG. 6A and FIG. 6B. In particular, the first coupling mechanism 92 and second coupling mechanism 96 may be configured as male components for coupling to female components (i.e. first and second median apertures 73, 75) of the slot divider 60.

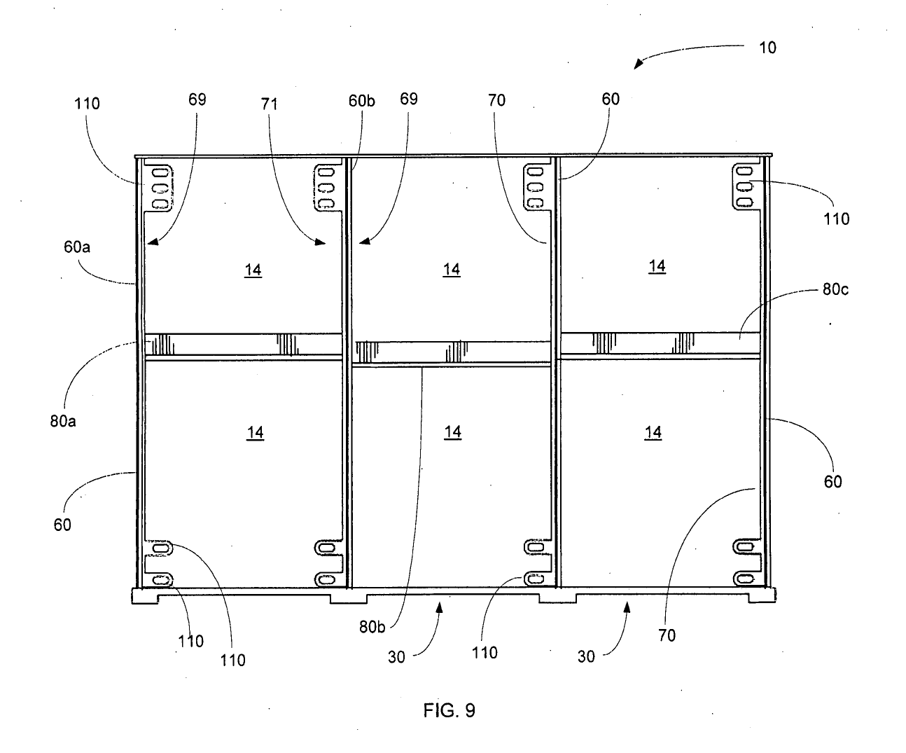

Referring now to FIG. 8, the first and second coupling mechanisms 92, 96 are shown in a preferred embodiment, coupling with the first median aperture 73 and the second median aperture 75. The first and second median apertures 73, 75 are configured to pass through the slot divider 60 from the first side 69 to the second side 71. The first and second coupling mechanisms 92, 96 are configured to be inserted into the first median aperture 73 and the second median aperture 75.

As with the receptacles 22, 42 of the frontward panel 20 and the rearward panel 40, each of the first and second median apertures 73, 75 may have two abutments forming bin latch strikes 74, 76 (although only one abutment of the bin latch strikes 74, 76 is illustrated). For example, the first median aperture 73 may have two abutments of the bin latch strike 74 on opposing walls of the first median aperture 73. Similarly, the second median aperture 75 may have two abutments of the bin latch strike 76 on opposing walls of the second median aperture 75.

In a preferred embodiment, both the first and second coupling mechanisms 92, 96 are configured to be inserted into both of the first and second median apertures 73, 75. Accordingly, the first median aperture 73 may be identical to the second median aperture 75, except that the first median aperture 73 is separated from the second median aperture 75 by a median separation distance 78. In this manner, both the first and second coupling mechanisms 92, 96 may be coupled to either the first or second median apertures 73, 75 of the slot divider 60.

In such a configuration, both the first and second coupling mechanisms 92, 96 may be inserted into either the first or second median apertures 73, 75. In a preferred embodiment, the first and second coupling mechanisms 92, 96 may be inserted into an upper portion of median apertures 73, 75 where the abutments of the bin latch strikes 74, 76 are not present. Once inserted, the first and second coupling mechanisms 92, 96 can be slid into a locked (i.e. coupled) position to secure each end 91, 95 of the slot median 80 against the bin latch strikes 74, 76 of either the first median aperture 73 or the second median aperture 75 of the slot divider 60.

The first and second coupling mechanisms 92, 96 of the slot median 80 and corresponding first and second median apertures 73, 75 may be configured such that the first and second coupling mechanisms 92, 96 may be coupled to either side 69, 71 of the slot divider 60. The first and second bin latch strikes 74, 76 may be centered within the median aperture depth 77. In this manner, the bin latch strike depth 79 between the first side 69 of the slot divider 60 and the abutments of the bin latch strikes 74, 76 is equal to the bin latch strike depth 79 between the second side 71 of the slot divider 60 and the abutments of the bin latch strikes 74, 76. The member length 99 of either the first or second coupling mechanisms 92, 96 may be equal to the median aperture depth 77 minus the bin latch strike depth 79 (i.e. member length 99=median aperture depth 77−bin latch strike depth 79). In this manner, the first and second coupling mechanisms 92, 96 may enter the first and second median apertures 73, 75 from either the first side 69 or the second side 71 of the slot divider 60.

While a latch and strike plate configuration has been illustrated in a preferred embodiment, it should be understood that the coupling mechanisms 92, 96 may take other forms to couple the slot median 80 to the slot dividers 60. Furthermore, other latch arrangements are possible. For example, the first and second coupling mechanisms 92, 96 are shown in a T-shaped configuration (i.e. terminating at a block-shaped median latch 94, 98). However, other configurations of the first and second locking mechanisms 92, 96 are possible, such as an L-shaped or Y-shaped configuration. Furthermore, the first and second coupling mechanisms 92, 96 may have different, rather than identical, configurations. The resulting median apertures 73, 75 of the slot dividers 60 would be changed accordingly.

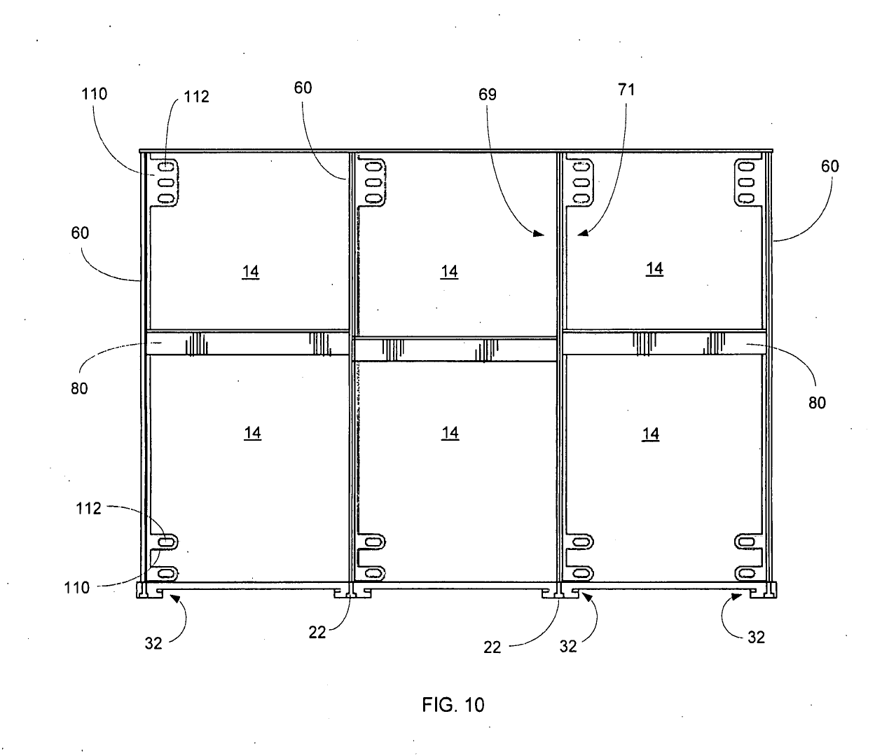

In FIG. 9, a bottom view of the shelf divider 10 is shown in one embodiment. The shelf divider 10 has been configured with six bins 14 using four slot dividers 60 and three slot medians 80a, 80b, 80c. The front of the shelf divider 10 has been configured with slot label holders 30.

Two slot dividers 60a, 60b arranged side-by-side may form a slot 12 when coupled to the frontward panel 20 and the rearward panel 40 and separated by one or more of the equal segments 24, 44 (as depicted in FIG. 1). Two slot dividers 60a, 60b are also coupled to the skit median 80a, which subdivides a slot 12 into two bins 14. On one side, the slot median 80a is coupled to the first side 69 of one slot divider 60a. On the other side of the slot median 80a, the slot median 80a is coupled to the second side 71 of the other slot divider 60b arranged side-by-side with the one slot divider 60a.

As seen in FIG. 9 to FIG. 11, any two side-by-side slot medians 80a, 80b, 80c are offset from each other due to their respective connections to the slot dividers 60. The outside slot medians 80a, 80c are coupled to their respective slot dividers using the second bin latch strike 76; whereas the middle slot median 80b is coupled to its respective slot dividers using the first bin latch strike 74. The leftmost slot median 80a is coupled to the second side 71 of the slot divider 60b and the middle slot median 80b is coupled to the first side 69 of the slot divider 60b. In this manner, the slot medians 80a, 80b, 80c alternate being coupled with corresponding first bin latch strikes 76 and with corresponding second bin latch strikes 76.

This arrangement results in side-by-side slot medians 80 being positioned the fixed distance 78 from each other. This arrangement also results in alternating pattern which allows the slot medians 80a, 80b, 80c to be identical in construction and the slot dividers 60 to be thin, thereby maximizing storage space and costs.

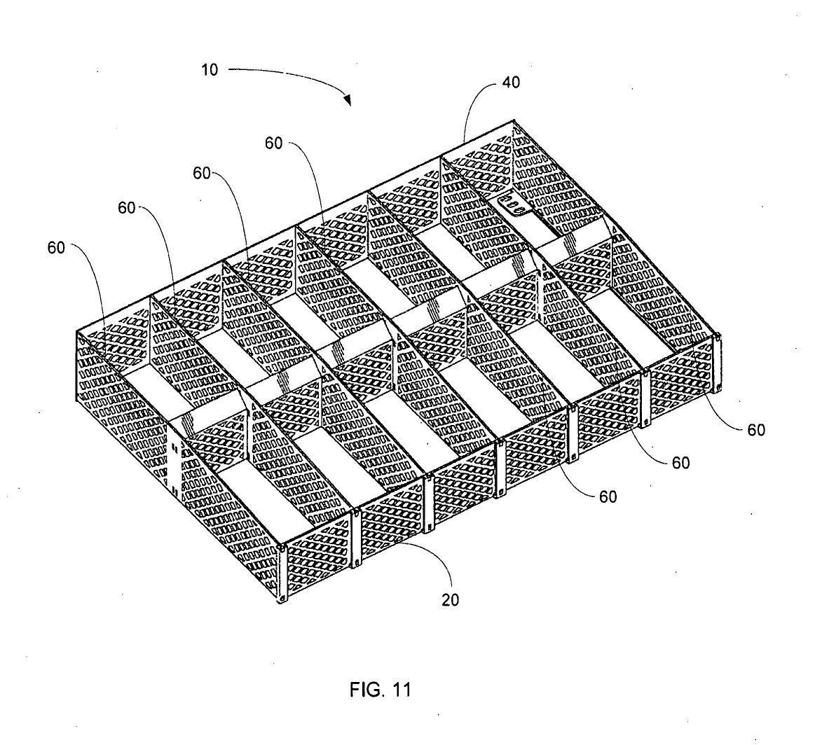

FIG. 10 shows a top view of the shelf divider 10 in one embodiment. As illustrated, the opposing grooves 32 of the slot label holders 30 may receive a label (not shown) from above such that the label may slide into the opposing grooves 32. Similarly, the frontward panel 20 may have receptacles 22 which may be entered from above. The first locking mechanism 62 of each of the slot dividers 60 may slide into the receptacle 22 from above.

A rivet 120 may be used to couple the shelf divider to a shelf (not shown) through the coupling device aperture 112. As best seen in FIG. 5, the rivet 120 is placed within the coupling device aperture 112 to attach the base 70 of the slot divider 60 to the surface of the shelf. In a preferred embodiment, where the frontward panel 20 includes receptacles 22 which are entered from above such as seen in FIG. 10, attaching the base 70 of the slot divider 60 to the surface of the shelf ensures that the shelf divider 10 may not be disassembled without first detaching the shelf divider 10 from the surface of the shelf. Instead, where the base 70 of each slot divider 60 in a shelf divider 10 is attached to the surface of a shelf by one or more coupling devices 110, the frontward panel 20 cannot be separated from the slot dividers 60 without first separating the slot divider 60 from the shelf by first removing the rivets 120.

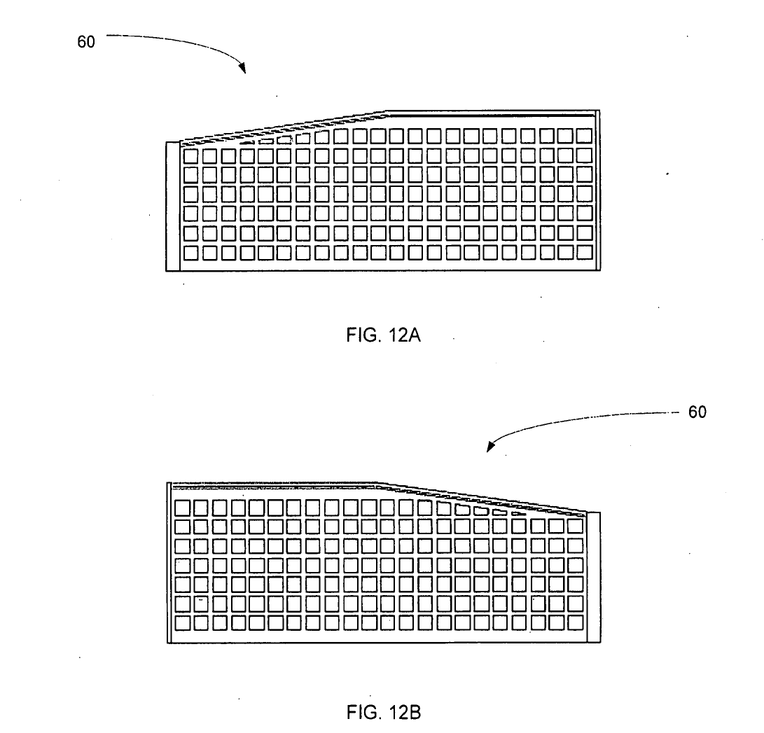

FIG. 11 shows a shelf divider 10 in another embodiment of the present invention. As illustrated, different numbers of slot dividers 60 may be used to create shelf dividers 10 in different configurations. The frontward panel 20 and the rearward panel 40 may be configured with different number of equal segments 24 to make any number of slots 12. Similarly, it should be understood that a plurality of frontward panels 20 may be connected together to create chains of frontward panels. The rearward panels 40 may be similarly combined.

The shelf divider 10 of the present invention is configured to provide advanced storage and organization to various types of shelving known in the art. For example, arrangements of the shelf divider 10 are adaptable to be configured for at least four of the most common types of shelving. In particular, different types of shelving having differently spaced mounting holes depending on the particular manufacturer. The shelf divider 10 is designed to adopt to configure to shelving already used by potential customers.

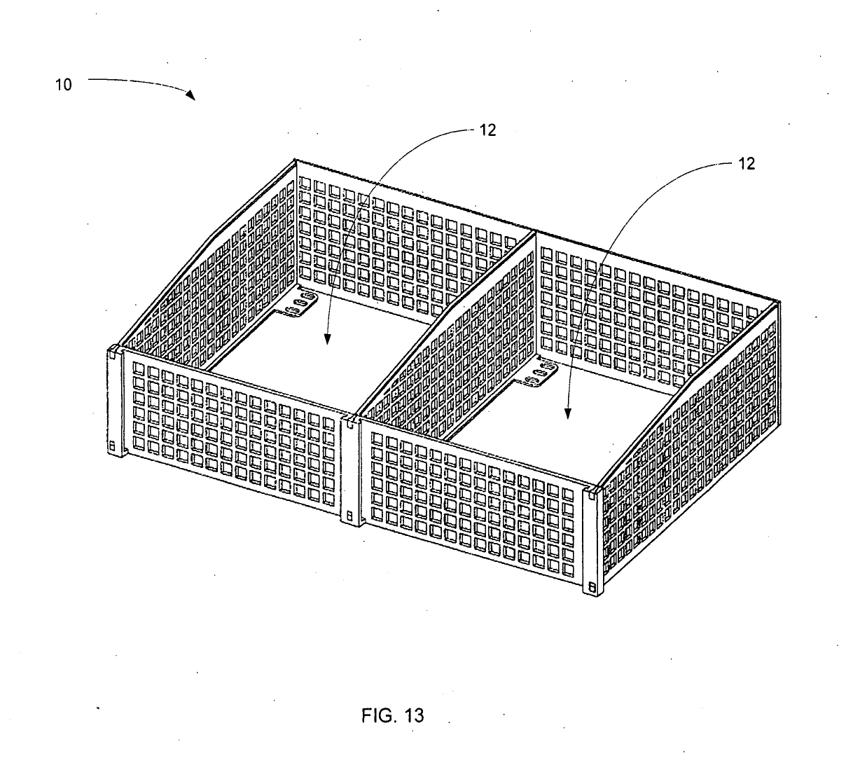

FIG. 12A and FIG. 12B show side views of a slot divider 60 having different patterns in the body of the slot divider 60. It should be understood that any number of patterns may be used as would be understood by a person skilled in the art. Various patterns may allow for reduced weight of the slot dividers 60 and/or the shelf divider 10, while maintaining strength and rigidity. Different patterns may also promote the stacking of components. Furthermore, different patterns may allow a user to see through the components or parts of the shelf divider 10 to the contents contained within the slots 12 or bins 14.

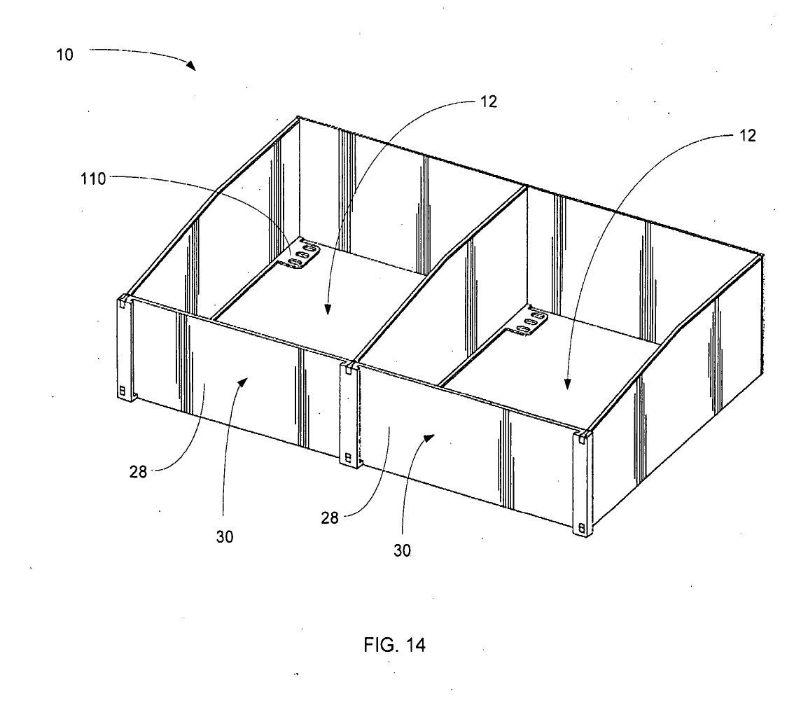

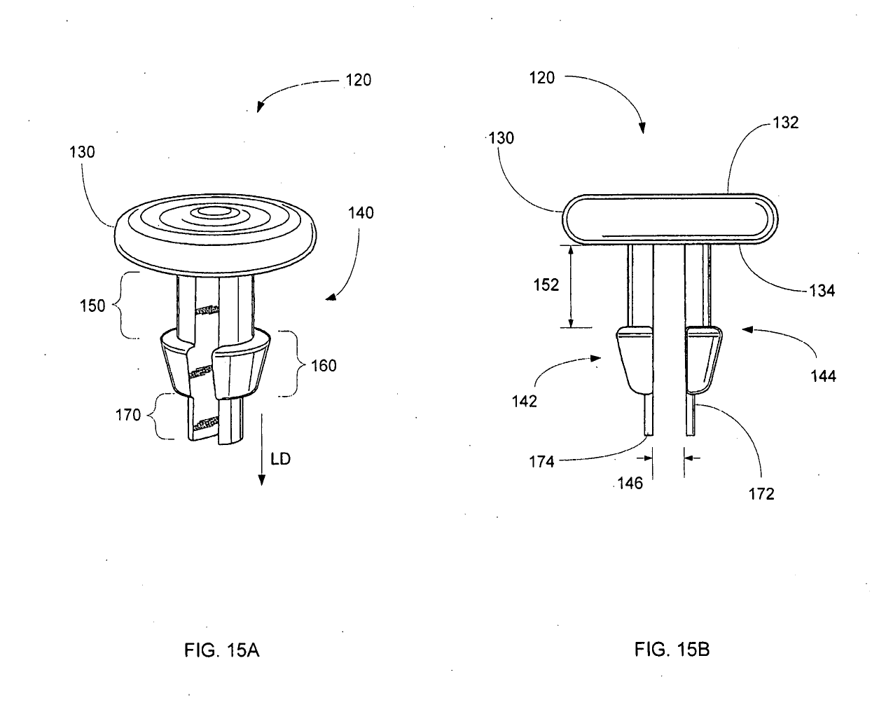

FIG. 13 and FIG. 14 show variants of the shelf divider 10 in different embodiments. In some embodiments the median slots 80 are not utilized and the shelf divider 10 provides larger slots 12 without being subdivided into smaller bins 14. Furthermore, the patterns on the components (i.e. frontward panel 20, rearward panel 40, slot dividers 60 and slot medians 80) may include squares, parallelograms, quadrilaterals, triangles, and the like. Furthermore, in some embodiments the components may be formed of a solid material, such as a plastic, metal, and the like. Other materials are also possible.

Different sized frontward panels 20 may have different sized slot label holders 30. In other embodiments, such as when the frontward panel is configured with an outward face 28 which is solid, the frontward panel 20 may not have a distinct slot label holder 30 at all. Instead, the outward face 28 of the frontward panel 20 may provide a surface for an adhesive such as a label sticker (not shown) to be placed.

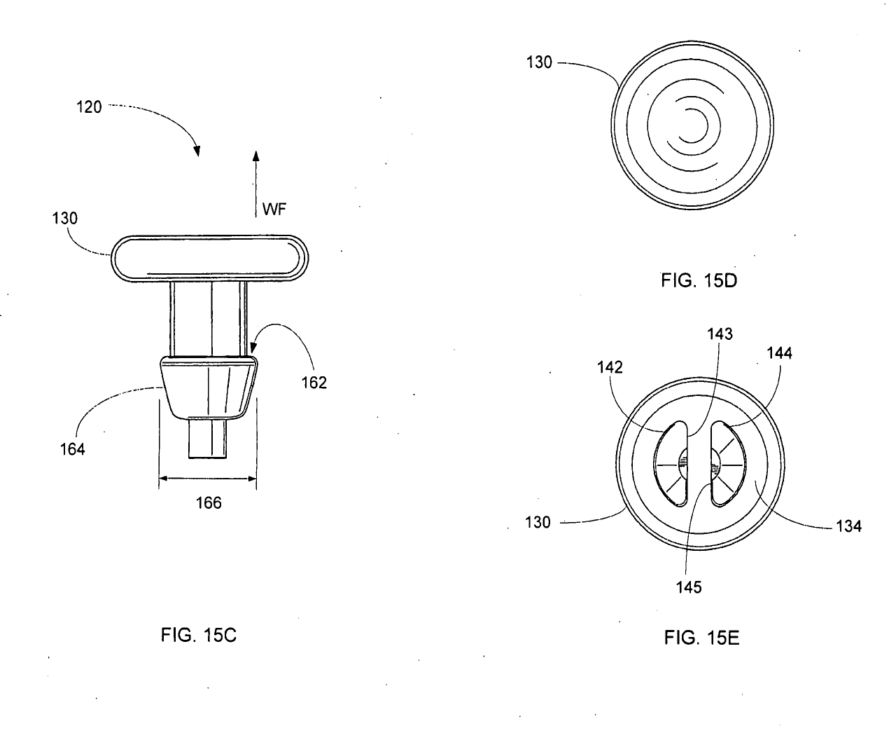

The shelf divider 10 may be coupled to a surface of a shelf by use of traditional nuts and bolts, Christmas tree pins, screws or adhesives. A preferred embodiment is shown in FIGS. 15A to 15E. Referring now to FIG. 15A to FIG. 15E, a rivet 120 in accordance with an embodiment of the present invention is illustrated. The rivet 120 may be used to couple the base 70 of the slot divider 60 to a surface of a shelf (not shown). As previously described, the rivet 120 in a preferred embodiment may couple the base 70 of the slot divider 60 to the shelf surface such that the frontward panel 20 cannot be detached or decoupled from the slot divider 60 without first removing the rivet 120. Accordingly, the slot divider 60 must be detached from the shelf by first removing the rivet 120 in order to decouple the shelf divider 10 from the shelf and/or disassemble the shelf divider 10.

The rivet 120 may include a top portion 130 and an insertion portion 140 extending in a longitudinal direction LD. The top portion 130 may be used to place or push the insertion portion 140 of the rivet 120 through the coupling device 110 and into an aperture of the shelf. For example, as shown in FIG. 15A to FIG. 15E, the top portion 130 of the rivet 120 may be circular, with a flat portion 132 for pressing the rivet 120 into the shelf. Other shapes are also possible. The underside of the top portion 130 may be known as the coupling device engagement surface 134.

The insertion portion 140 of the rivet 120 may include a shelf portion 150, an engagement portion 160 and a release portion 170. The insertion portion 140 may be formed from a first member 142 and a second member 144 extending in the longitudinal direction LD, separated by an insertion distance 146. Each of the first member 142 and the second member 144 may have inner engagement surfaces 143, 145. Each of the first member 142 and the second member 144 may be directly coupled to or integrally formed with the top portion 130 of the rivet 120.

The engagement portion 160 of the rivet 120 is configured to abut a bottom of the shelf (not shown). The engagement portion 160 may include a shelf engagement surface 162 and an engagement body 164. Upon installation, the shelf engagement surface 162 of the engagement portion 160 may abut the bottom of the shelf with the coupling device engagement surface 134 of the top portion 130 abutting the top surface of the coupling device 110. In this manner, the rivet 120 is operable to couple the coupling device 110 and therefore the slot divider 60 to the shelf.

The shelf portion 150 of the insertion portion 140 may physically separate the top portion 130 from the engagement portion 160. The shelf portion 150 may have a shelf portion length 152. In use, the shelf portion 150 may transition from the top surface of the coupling device 110 of the slot divider 60 to the underside of the shelf. Accordingly, the shelf portion length 152 may be designed for standard or expected shelf thicknesses. In this manner, the shelf portion length 152 may be designed to incorporate the thickness of the coupling device 110 and a predetermined thickness for standard shelving. The metal thickness of a typical shelf does not exceed 14 gauge or 60-70 thousands of an inch.

The engagement portion 160 of the rivet 120 may be designed to withstand standard withdrawal forces WF trying to pull the shelf divider 10 and therefore the rivet 120 off of or out of the shelving. The engagement portion 160 may have an engagement body 164 configured to absorb and distribute the withdrawal forces WF. The engagement body 164 may be made of a resilient material such as plastic and the like. Furthermore, the shape of the engagement body 164 may be configured to direct the withdrawal forces WF into a longitudinal direction LD of each of the first member 142 and second member 144. In this manner, the withdrawal forces WF may be absorbed by the resiliency of the insertion portion 140, such as provided by the resilient material and the like. The shape of the engagement body 164 may reduce the occurrence of failure of the rivet 120 due to any withdrawal force WF.

The rivet 120 may also include a release portion 170 for releasing the rivet 120 and therefore the slot divider 60 from being coupled to the shelf. The release portion 170 may be located at the terminal ends 174 of the first member 142 and the second member 144 of the insertion portion 140. The release portion 170 may provide contact surfaces 172 on both the first member 142 and second member 144 of the insertion portion 170 for pressing the contact surfaces 172 together. The contact surfaces 172 may be manually depressed. In other embodiments, a tool may be used such as a pair of pliers and the like.

When inwardly depressed, the release portion 170 on each of the first member 142 and second member 144 may flex or rotate the insertion portion 140 about the top portion 130 such that the inner engagement surface 143, 145 of the engagement portion 160 are pressed closer together. The contact surfaces 172 may be pressed together to such an extent that the inner engagement surfaces 143, 145 on the first member 142 and second member 144 are less than the insertion distance 146 and the engagement width 166 is less than the holes in the shelving.

Once the shelf engagement surface 162 is no longer in contact or engaged with the bottom surface of shelving and the engagement width 166 is less than the width or size of the holes of the shelving, the rivet 120 may be withdrawn in the longitudinal direction LD from the shelving using the withdrawal force WF. Once the rivets 120 are withdrawn from the shelf divider 10, the shelf divider 10 may be detached or decoupled to the shelving and disassembled.

The rivet 120 may be manufactured out of a resilient material, such as a plastic and the like. Furthermore, a hard plastic may be used to provide strength to the coupling of the slot divider 60 to the surface of the shelf. In a preferred embodiment, rivets 120 of different sizes and shapes having different shelf portion lengths 152 may be incorporated into a kit for building a shelf divider 10. In this manner, the kit may be operable to build shelves for different types of conventional shelving.

Although this disclosure has described and illustrated certain preferred embodiments of the invention, it is also to be understood that the invention is not restricted to these particular embodiments rather, the invention includes all embodiments which are functional, or mechanical equivalents of the specific embodiments and features that have been described and illustrated herein. Furthermore, while the disclosure generally describes a shelf divider 10 in detail, the description also applies to a kit for building the shelf divider 10 as described herein.

It will be understood that, although various features of the invention have been described with respect to one or another of the embodiments of the invention, the various features and embodiments of the invention may be combined or used in conjunction with other features and embodiments of the invention as described and illustrated herein. The scope of the claims should not be limited to the preferred embodiments set forth in the examples, but should be given the broadest interpretation consistent with the description as a whole.

The embodiments of the invention in which an exclusive property or privilege is claimed is defined as follows:

1. A kit for building a shelf divider comprising:
a frontward panel having a first plurality of receptacles;
a rearward panel having a second plurality of receptacles; and
a plurality of slot dividers, each of the plurality of slot dividers including:
a first locking mechanism disposed at a first end of each slot divider for coupling to one of the first plurality of receptacles of the frontward panel; and
a second locking mechanism disposed at a second end of each slot divider for coupling to one of the second plurality of receptacles of the rearward panel.

2. The kit of claim 1, wherein the frontward panel is segmented into a plurality of equal segments by the first plurality of receptacles and wherein each equal segment includes a slot label holder configured to secure a slot label.

3. The kit of claim 2, wherein the slot label is to be secured adjacent to an outward face of each equal segment of the frontward panel and each slot label holder comprises:
opposing grooves to receive opposing sides of the slot label; and
an insertion member to stop further insertion of the slot label once the slot label is fully received.

4. The kit of claim 3, wherein each insertion member is an abutment coupled to the outward face of each equal segment and centrally disposed between the opposing grooves of each slot label holder.

5. The kit of claim 4, wherein each slot label holder further comprises a withdrawal member to stop withdrawal of the slot label once the slot label is fully received.

6. The kit of claim 1,
wherein the first locking mechanism on each of the plurality of slot dividers includes a first member extending from the first end of the slot divider, the first member terminating at a first latch;
wherein each of the first plurality of receptacles of the frontward panel includes a first latch strike for receiving the first latch once the first latch is inserted into one of the first plurality of receptacles;
wherein the second locking mechanism on each of the plurality of slot dividers includes a second member extending from the second end of the slot divider, the second member terminating at a second latch; and
wherein each of the second plurality of receptacles of the rearward panel includes a second latch strike for receiving the second latch once the second latch is inserted into one of the second plurality of receptacles.

7. The kit of claim 1, wherein the frontward panel and the rearward panel are segmented into a plurality of equal segments having a segment length, the frontward panel being segmented by the first plurality of receptacles and the rearward panel being segmented by the second plurality of receptacles.

8. The kit of claim 7, wherein two slot dividers of the plurality of slot dividers arranged side-by-side form a slot when coupled to the frontward and rearward panel and separated by one of the plurality of equal segments having the segment length, wherein the kit further comprises:
a slot median having a median length equal to the segment length, the slot median being coupled to each of the two slot dividers arranged side-by-side.

9. The kit of claim 8, wherein the slot median further comprises a bin label holder configured to secure a bin label.

10. The kit of claim 8, wherein the slot median further comprises:
a first median latch disposed at a first end of the slot median for coupling to one of the two slot dividers arranged side-by-side; and
a second median latch disposed at a second end of the slot median for coupling to another of the two slot dividers arranged side-by-side.

11. The kit of claim 10,
wherein each of the plurality of slot dividers has a first side and a second side;
wherein each slot divider further includes a first median aperture passing through each slot divider from the first side to the second side; and
wherein the first median aperture is symmetrical from both the first side and the second side of each slot divider and the slot median is configured to be coupled to either the first side or the second side of each slot divider when the first median latch or the second median latch is received within the first median aperture.

12. The kit of claim 11, wherein each of the plurality of slot dividers further includes a second median aperture identical to the first median aperture, the second median aperture displaced a median separation distance from the first median aperture along the slot divider.

13. The kit of claim 12, wherein at least one of the plurality of slot dividers is configured to be coupled to:
a first slot median on the first side of the at least one slot divider when the first median latch of the first slot median is received within the first median aperture; and
a second slot median on the second side of the at least one slot divider when the second median latch of the second slot median is received within the second median aperture.

14. The kit of claim 1, wherein each of the plurality of slot dividers has a base, and wherein the base has at least one coupling device for coupling the base of each slot divider to a surface of a shelf.

15. The kit of claim 14, wherein the kit further comprises a rivet configured to couple the coupling device to the surface of the shelf,
wherein when the rivet has coupled the coupling device to the surface of the shelf, the frontward panel cannot be decoupled from the slot divider and the surface of the shelf until the rivet is first removed.

16. The kit of claim 1, wherein each of the rearward member, the frontward member and plurality of slot dividers are integrally formed from a single piece of plastic.

17. A shelf divider comprising the kit according to claim 1.

18. A rivet comprising:
a top portion;
an insertion portion extending in a longitudinal direction including a first member and a second member separated by an insertion distance, the insertion portion having:
a shelf portion coupled to the top portion, the shelf portion having a shelf portion length;
an engagement portion coupled to the shelf portion; and
a release portion;
wherein the release portion is configured to allow the rivet to be removed from a hole.

19. The rivet of claim 18, wherein the shelf portion length is pre-determined to equal the thickness of a coupling device of a shelf divider and a thickness of a shelf.
